(19) United States
(12) Patent Application Publication
(10) Pub. No.: US 2008/0117521 A1
(43) Pub. Date: May 22, 2008

(54) LIQUID LENSES WITH CYCLOALKANES

(75) Inventors: Thomas Nikita Krupenkin, Warren, NJ (US); Anthony Edward Novembre, Martinsville, NJ (US)

Correspondence Address: HITT GAINES, PC;ALCATEL-LUCENT, PO BOX 832570, RICHARDSON, TX, 75083, US

(73) Assignee: Lucent Technologies Inc., Murray Hill, NJ (US)

(21) Appl. No.: 11/560,988

(22) Filed: Nov. 17, 2006

(51) Int. Cl. G02B 3/12

(52) U.S. Cl. 359/665

(57) ABSTRACT

An apparatus that comprises a substrate with a top surface and a liquid lens on the top surface and clear retaining fluid surrounding the lens. One of the retaining fluid and liquid lens comprises a nonpolar liquid, and the other of the retaining fluid and liquid lens comprises a polar liquid. The nonpolar liquid includes one or more cyclic saturated organic compounds.

### TECHNICAL FIELD OF THE INVENTION

The present invention is directed, in general, to refractive optics, and more particularly, to a liquid lens and methods of using a liquid lens.

### BACKGROUND OF THE INVENTION

This section introduces aspects that may be helpful to facilitating a better understanding of the invention. Accordingly, the statements of this section are to be read in this light. The statements of this section are not to be understood as admissions about what is in the prior art or what is not in the prior art.

There are many optical applications that use refractive optics (e.g., lenses). Refractive optics using liquid lenses provide the opportunity to tune a lens easier, and sometimes to a greater extent, than possible for flexible polymeric or mechanically adjustable lenses. In optical apparatuses ranging from telescopes to micro-electro-mechanical systems (MEMS), it is often important to make an apparatus that is as compact as possible. Unfortunately, some conventional liquid lenses have a small refractive index contrast, which translates into a substantially longer than desired focal length. This in turn, necessitates using a large amount of space for the optical components of the apparatus, thereby limiting the extent to which the apparatus can be miniaturized.

Embodiments of the invention address these deficiencies by providing an apparatus that features a liquid lens with a shorter focal length than hitherto possible.

### SUMMARY OF THE INVENTION

To address one or more of the above-discussed deficiencies, one embodiment is an apparatus. The apparatus comprises a substrate with a top surface and a liquid lens on the top surface. A clear retaining fluid surrounds the lens. One of the retaining fluid and liquid lens comprises a nonpolar liquid, and the other of the retaining fluid and liquid lens comprises a polar liquid. The nonpolar liquid includes one or more cyclic saturated organic compounds.

Another embodiment is a method of use that comprises transmitting an optical signal using the above-described liquid lens. Transmitting includes directing the optical signal towards the liquid lens, the liquid lens being located a top surface of a substrate and surrounded by the above-described clear retaining fluid. Transmitting also includes refracting the optical signal at an interface between the liquid lens and retaining fluid and passing the refracted optical signal onto a receiving surface.

### BRIEF DESCRIPTION OF THE DRAWINGS

The invention is best understood from the following detailed description, when read with the accompanying FIGUREs. Various features may not be drawn to scale and may be arbitrarily increased or reduced in size for clarity of discussion. Reference is now made to the following descriptions taken in conjunction with the accompanying drawings, in which:

FIGS. 1-4 presents a cross-sectional view of an example apparatuses that comprising the liquid lens of the invention; and

FIGS. 5-6 present plan views of the liquid lens depicted in FIG. 2 at different stages of use.

### DETAILED DESCRIPTION

Embodiments of the invention benefit from the recognition that the refractive index contrast, that is the difference, between a liquid lens and a surrounding retaining fluid can be increased by using a nonpolar fluid that comprises cyclic saturated organic compounds. In particular, one of a retaining fluid surrounding a liquid lens, or the liquid lens itself, comprises a nonpolar fluid that includes a cyclic saturated organic compound. The other of the retaining fluid and liquid lens comprises a polar liquid. While cyclic saturated organic compounds have been considered for ultraviolet lithography applications, their beneficial use in refractive liquid lens optics has not previously been recognized.

One embodiment of the invention is an apparatus. In some cases, the apparatus can be a tunable light-processing device. In tunable devices, the direction of light passed through the liquid lens, e.g., to focus the light, can be adjusted by applying a voltage to the liquid lens or to the retaining fluid to change the shape of the liquids lens. Example devices include MEMS devices that are incorporated into image projectors, televisions, and computer or cell-phone displays. In other cases, however, the apparatus can be a passive light-processing device. In passive a light-processing device, the direction of light passing through the liquid lens is not altered by applying a voltage to change the shape of the lens.

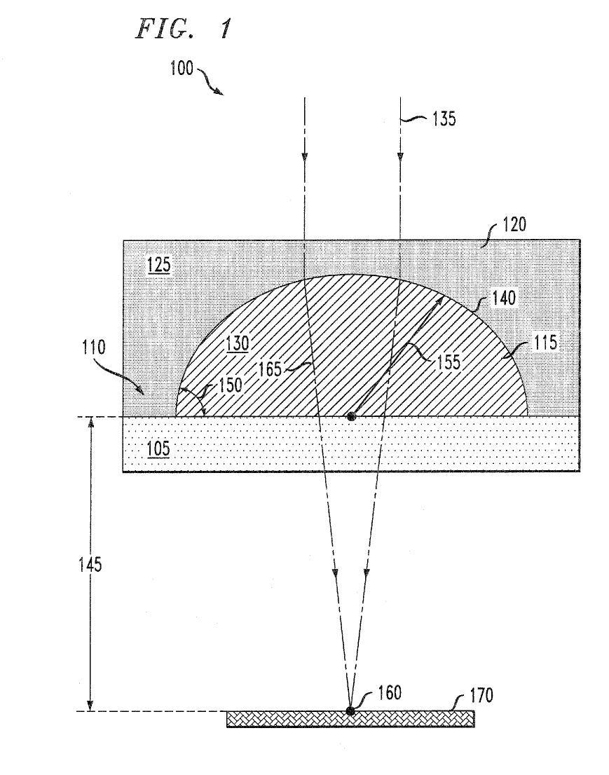

FIG. 1 presents a cross-sectional view of an example apparatus 100. The apparatus 100 comprises a substrate 105 with a top surface 110, a liquid lens 115 on the top surface 110 and a clear retaining fluid 120 surrounding the lens 115. One of the retaining fluid 120 and liquid lens 115 comprises a nonpolar liquid 125, and the other of the retaining fluid 115 and liquid lens 115 comprises a polar liquid 130. The nonpolar liquid includes one or more cyclic saturated organic compound or compounds.

The term clear retaining fluid as used herein refers to a retaining fluid 120 that is substantially transparent to a light 135 (e.g., a U.V. or visible light configured as an optical signal to communicate information) configured to pass through the lens 115 for the purposes of altering the direction of the light 135. E.g., in some cases, at least about 80%, and more preferably at least about 90%, of the light 135, at the wavelength of interest, is transmitted through a 1 cm pathlength of retaining fluid.

The term polar liquid 130 as used herein refers to a liquid having a dielectric constant of about 20 or greater (e.g., water and acetone have dielectric constants of about 80 and 21, respectively). The term non-polar liquid 125 as used herein refers to a liquid that has a dielectric constant of less than about 20.

The refractive index (nₙₚ) of the non-polar liquid 125 and refractive index (nₚ) of the polar liquid 130 are substantially different from each other. E.g., in some preferred embodiments, the difference (Δn=nₚ−nₙₚ) is greater than about 0.15, and more preferably, greater than about 0.25, at the wavelength of light 135 passed through the lens 115 (e.g., 589 nm or other visible or U.V. wavelengths). In other cases a ratio of nₙₚ to nₚ ranges from about 1.13:1 to 1.2:1.

In addition to increasing the refractive index contrast with the liquid lens 115, the retaining fluid 120 surrounding the liquid lens 115 advantageously protects the liquid lens 115 from evaporation. The retaining fluid 120 can also deter the undesired movement of the liquid lens 115 due to, e.g., movement or vibration of the apparatus 100.

It is desirable for the liquid lens 115 and retaining fluid 120 to form a refractive index contrast interface 140 between these two structures 115, 120. A sharp interface is facilitated by selecting nonpolar liquids 125 and polar liquids 130 that are substantially immiscible in each other. E.g., in some preferred embodiments, the volume fraction solubility of the nonpolar liquid 125 in the polar liquid 130 is about 1 percent or less and more preferably, about 0.1 percent or less at the operating temperature range of the apparatus 100.

A nonpolar liquid 125 that comprises, and sometimes is, a cyclic saturated organic compound has several advantageous. Cyclic saturated organic compounds having a high density (e.g., a density of about 0.95 gm/cm³ or greater) also have a high refractive index (e.g., about 1.5 or higher at visible wavelengths). Consequently, there is a large refractive index difference compared to polar liquids or lower density non-polar alkanes. Cyclic saturated organic compounds are also immiscible in polar liquids, which is conducive to forming a sharp interface 140 lens 115 and fluid 120. Cyclic saturated organic compounds are more transparent to a broad range of U.V. and visible wavelengths of light 135, as compared to e.g., unsaturated acyclic or cyclic organic compound.

It is desirable for the cyclic saturated organic compound to be free of any conjugation of pi-bonds so as to minimize the absorption of the light 135 passed through the lens 115. Preferred embodiments of the cyclic saturated organic compound include a polycyclic cycloalkane. The polycyclic cycloalkane comprises at least two saturated hydrocarbon rings joined together with common atoms (e.g., ortho-fused rings). Some preferred polycyclic cycloalkanes have a refractive index ranging from about 1.5 to 1.6 (e.g., at about 589 nm or other visible wavelengths) Examples include ortho-fused and ortho- and peri-fused saturated hydrocarbons rings having 2 to 6 rings, such as decalin (I), perhydrofluorene (II), or perhydrophenanthrene (III):

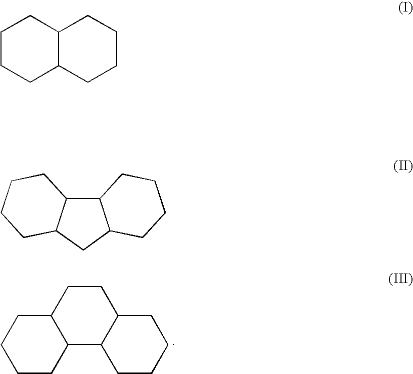

Polycyclic cycloalkanes having a large number of rings (e.g., 4 or more rings) are desirable because such compound tend to have a higher refractive index than polycyclic cycloalkanes with a lesser number of rings, but still remain transparent at visible or U.V. wavelengths. Examples include perhydropyrene (IV), perhydrotetracene (V), perhydronapthoanthracene (VI), and perhydronapthotetracene (VII) and adamentane (VIII):

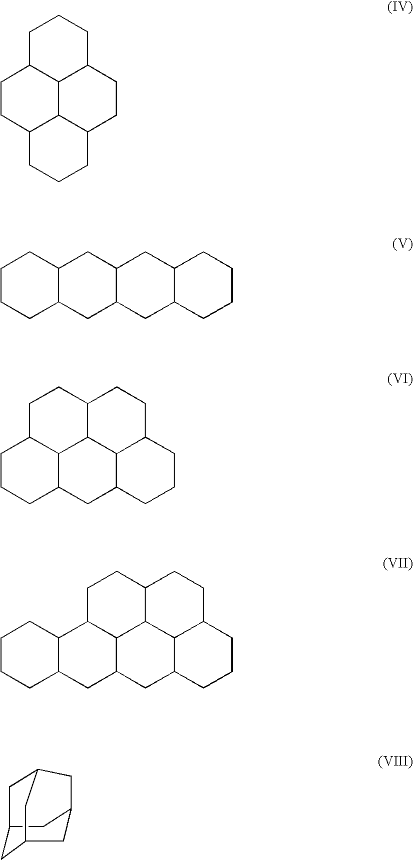

It can be advantageous for the nonpolar liquid 125 to include more than one cyclic saturated organic compound, or other organic compounds, to increase the refractive index contrast (e.g., increase Δn). E.g., the nonpolar liquid 125 can comprise one or more first cyclic saturated organic compounds that is a liquid in its pure form at the operating temperature range of the apparatus (e.g., about 0 to 50° C., and in some cases about 20° C.), plus a one or more second cyclic saturated organic compounds that is a solid in its pure form, but is soluble in the first cyclic saturated organic compound. Example first cyclic saturated organic compounds include two- or three-ring polycyclic cycloalkanes such as decalin (I), perhydrofluorene (II), or perhydrophenanthrene (III). Example second cyclic saturated organic compounds include four-ring or larger polycyclic cycloalkanes such as perhydropyrene (IV), perhydrotetracene (V), perhydronapthoanthracene (VI), and perhydronapthotetracene (VII) or adamentane (VIII).

In addition to increasing the refractive index of the nonpolar liquid 125 the second cyclic saturated organic compound can be added to lower the melting point of the nonpolar liquid 125. This may be useful when it is desirable for the nonpolar liquid 125, configured as either the liquid lens 115 or retaining fluid 120, to become solidified by lowering the temperature of the apparatus 100. E.g., after tuning the shape of the liquid lens 115, the nonpolar liquid 125 is solidified. Other methods to solidify liquid lens are discussed in U.S. Pat. No. 6,936,196 which is incorporated by reference herein in their entirety.

The use of electrically conductive polar liquids 130 is desirable in embodiments where the liquid lens 115 or retaining fluid 120 is configured to be tunable by applying a voltage to the polar liquid 130 to change the shape of the lens 115. Example polar liquids 130 include molten salts or aqueous or organic solutions of salts, such as described in U.S. Pat. Nos. 6,538,823; 6,891,682; and the above-mentioned U.S. Pat. No. 6,936,196 patent, all of which are incorporated by reference herein in their entirety. Some preferred embodiments of the polar liquid 130 have an index of refraction ranging from about 1.3 to 1.4 (e.g., at about 589 nm or other visible wavelengths) Other preferred embodiments in include room temperature molten salts like 1-ethyl-3-methylimidazolium tetrafluoroborate.

In some cases to facilitate the focusing of light 135, the liquid lens 115 is preferably configured as a droplet disposed on the substrate's surface 110. In other instances, however, the liquid lens 115 can be configured to have other shapes, e.g., an ellipsoidal or planar shape, if desired.

A focal length (f) 145 of the lens 115 can be changed by changing its shape. E.g., the shape of a liquid lens 115 configured as a droplet, such as shown in FIG. 1, can be changed as characterized by a change in the contact angle 150 formed between the liquid lens 115 and the substrate 110. For instance, the liquid lens 115 can range from a nearly spherical to a hemispherical-shaped droplet on the surface 110, for contact angles 150 ranging from about 180 to 90 degrees, respectively. One skilled in the art would understand how the contact angle 150 is dependent upon the interfacial tensions between substrate 110, liquid lens 115, and retaining fluid 120 (see e.g., U.S. Pat. No. 6,538,823).

The focal length 145 of the liquid lens 115 also depends upon the radius (r) 155 of the lens 115 and the refractive index contrast (e.g., Δn) between the lens 115 and the retaining fluid 120. The focal length 145 is given by the equation:

f=r/Δn

where r is the surface curvature of the lens 115 in meters (see e.g., the U.S. Pat. No. 6,538,823 patent). It follows therefore, that a ratio of the focal length 145 to the radius 155 of the liquid lens 115 is inversely related to Δn (e.g., f/r=1/Δn). Therefore the focal length 145 can be decreased by increasing Δn.

Consider embodiments of the apparatus 100 where the liquid lens 115 has a radius of about 100 microns. The liquid lens 115 is a polar liquid 130 having a refractive index of about 1.33, and the retaining fluid 120 is a non-polar liquid having a refractive index of about 1.5 to 1.6 (e.g., Δn=0.27 to 0.17). In such embodiments, the focal length 145 ranges from about 370 to 580 microns. That is, the ratio of focal length 145 to the radius 155 ranges from about 3.7:1 to 5.8:1. This is substantially shorter than a focal length 145 of about 1000 microns, obtained for a liquid lens 115 of the same curvature, but surrounded by a retaining fluid 120 having a refractive index of about 1.43 (e.g., Δn=0.1).

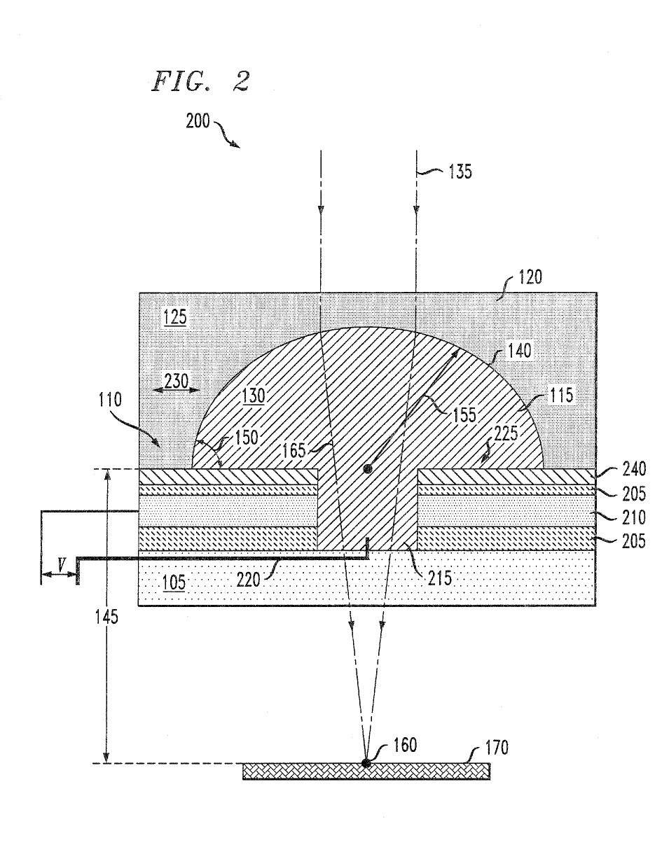

FIG. 2 (using the same reference numbers as FIG. 1) shows additional aspects of a preferred embodiment of the apparatus 200, where the liquid lens 115 is configured as a tunable liquid lens 115. The apparatus 200 further includes an insulating layer 205 on the substrate 105 and a plurality of electrodes 210 insulated from the liquid lens 115 by the insulating layer 205. As illustrated, the substrate 105 and insulating layer 205 can both be substantially planar.

In some cases, the insulating layer 205 can include an opening 215 to allow the liquid 110 to contact a biasing electrode 220 that is in contact with the liquid lens 115. As shown in FIG. 2, the substrate 105 can comprise the biasing electrode 220. In some cases, the substrate 105 itself is electrically conductive, and therefore can serve as the biasing electrode. This advantageously avoids the need to construct a separate biasing electrode in the substrate 105.

In some preferred embodiments one of the liquid lens 115 and the retaining fluid 120 is electrically conductive and is disposed over a surface 225 of the insulating layer 205, and the other of the liquid lens 115 or the retaining fluid 120 is not electrically conductive. E.g., in some cases, the liquid lens 115 comprises an electrically conductive polar liquid 130 (e.g., a molten salt or aqueous or organic solvent having salts dissolved therein), and the retaining fluid 120 is a non-conducting non-polar liquid 125 (e.g., a cyclic saturated organic compound such as decalin or perhydrofluorene). In other cases, liquid lens 115 is a non-conducting non-polar liquid 125 and the retaining fluid 120 is a conducting polar liquid 130.

The plurality of electrodes 210 are configured to adjust the shape of the liquid lens 115 (e.g., a lateral position 230 or a contact angle 150 of the liquid lens 115 relative to the insulating layer's surface 225) when a voltage (V) is applied between the liquid lens 115 (e.g., via biasing electrode 220) and one or more of the electrodes 210.

In some embodiments, it is desirable for the liquid lens 115, the insulating layer 205, the substrate 105 and the electrodes 210 to be transparent with respect to the light 135 to be passed through the lens 115. E.g., the transparent liquid lens 115 can comprise water or molten salt, the transparent insulating layer 205 can comprise a polyimide, the transparent conductive substrate 105 can comprise glass, silicon dioxide, quartz, sapphire, diamond or other transparent solid materials, and the transparent electrodes 210 can comprise indium tin oxide.

In some cases, the insulating layer's surface 225 is covered with a coating of low-surface-energy material 240. The coating 240 serves to adjust the contact angle 150 of the liquid lens 115 to a predefined value (e.g., from about 80 to 100 degrees in some embodiments). Adjusting the contact angle 150 advantageously modifies the refractive properties (e.g., focal length) of the liquid lens 115. The term low-surface-energy material, as used herein, refers to a material having a surface energy of about 22 dyne/cm (about 22×10⁻⁵ N/cm) or less. Those of ordinary skill in the art would be familiar with the methods to measure the surface energy of materials. In some instances, the coating 240 comprises a fluorinated polymer like polytetrafluoroethylene or other highly fluorinated hydrocarbon, or an alkylsilane like polydimethylsilane. In some instances, the insulating layer 205 and low surface energy coating 240 comprise a single material, such as Cytop® (Asahi Glass Company, Limited Corp. Tokyo, Japan), a fluoropolymer that is both an electrical insulator and a low-surface-energy material.

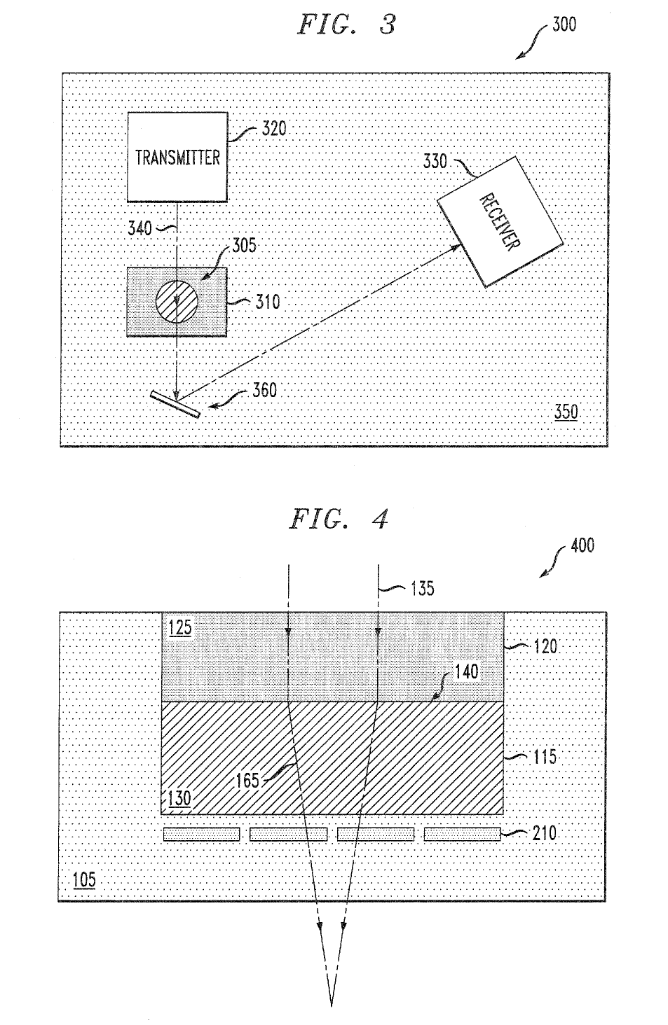

FIG. 3 shows a plan view of another preferred embodiment of the apparatus 300 configured as an optoelectronic device that comprises one or more liquid lens 305. The liquid lens 305 can comprise any of the embodiments of the liquid lenses and components, including a surrounding retaining fluid 310, as discussed above in the context of FIGS. 1-2. As illustrated in FIG. 3, the apparatus 300 further includes a transmitter 320 (e.g., a laser or lamp) and a receiver 330 (e.g., a photodetector or camera). The transmitter 320 provides an optical signal 340 which is received by the receiver 330. The liquid lens 305 is configured to direct the optical signal 340 from the transmitter 320 to the receiver 330. The lens 305, transmitter 320, and receiver 330 can be mounted on a substrate 350 (e.g., a printed circuit board or printed wafer board).

The liquid mirror 305 can be configured to alter the optical signal 340 in any number of ways familiar to those skilled in the art. E.g., the liquid lens 305 can alter the direction of the optical signal 340 by focusing or diffusing the signal 340. When the liquid lens 305 is configured as a tunable liquid lens, the shape or position of the lens 305 can be adjusted to improve the optical coupling between various components of the apparatus 300.

As further illustrated in FIG. 3, the apparatus 300 can further include a mirror 360, such as a liquid mirror as described in U.S. patent application Ser. No. 11/468,893, which is incorporated by reference in its entirety. Having both tunable liquid lenses 305 and liquid mirrors 360 in the same apparatus 300 advantageously allows the optical signal 340 to be adjusted and optimized over a broad range of distances and focal lengths. E.g., the optical signal 340 can be reflected from the mirror 360 to the liquid lens 305, which then focuses the optical signal 340 before it reaches the receiver 330. One skilled in the art would appreciate the variety of ways that a liquid mirror 360 and liquid lens 305 could be arranged in optoelectronic devices.

Another aspect of the invention is a method of use that comprises transmitting an optical signal using a liquid lens. Any of the embodiments of the liquid lenses described in the context of FIGS. 1-3 can be used in the method. E.g., one of the liquid lens 115 and retaining fluid 120 comprises a nonpolar liquid 125, and the other of the liquid lens 115 and retaining fluid 120 comprises a polar liquid 130, and the nonpolar liquid 125 includes a cyclic saturated organic compound.

As illustrated in FIG. 1, transmitting the optical signal (e.g., the light 135) includes directing the optical signal towards the liquid lens 115, the liquid lens 115 being located a top surface 110 of a substrate 105 and surrounded by a clear retaining fluid 120. Transmitting includes refracting the optical signal 135 at an interface 140 between the liquid lens 115 and retaining fluid 120. The refracted light 165 can then be passed onto a receiving surface 170 (FIG. 1).

In some cases, the optical signal comprises parallel beams of light 135 that are directed to the retaining fluid 120 and the liquid lens 110. The optical signal 135 can be refracted though the fluid 120 and lens 115 and thereby be focused or concentrated at a focal point 160. In such cases the liquid lens 115 is referred to as a concentrating lens. E.g., the concentrating liquid lens 115 comprises a material (e.g., a polar liquid 130) having a lower index of refraction than the surrounding retaining fluid 120 (e.g., a non-polar liquid 125). In such cases the receiving surface 170 at the focal point 160 of the lens, and can be part of an optical signal receiver e.g., a photodetector. In some embodiments, the focal length 145 between the liquid lens 115 and the receiving surface 170 ranges from about 3.7 to 5.9 times the radius 155 of the liquid lens 115.

In other cases, the optical signal 135, can be refracted through the lens 115 and fluid 120 and thereby be diverged into substantially parallel beams of light 135. In such cases the liquid lens 115 is referred to as a diverging lens. E.g., the diverging liquid lens 115 liquid lens 115 comprises a material (e.g., a non-polar liquid 125) having a higher index of refraction than the surrounding retaining fluid 120 (e.g., a polar liquid 130). The receiving surface 170, is such cases may be another lens or mirror located in the path of the parallel beams of light 135, which then focuses or reflect the optical signal 135 to another component of the apparatus 100.

In some preferred embodiments, transmitting the optical signal further includes tuning the liquid lens by changing the shape of the lens. For instance, as illustrated in FIG. 2, tuning the lens 115 can include applying a voltage (V) between an electrically conductive liquid lens 115 and one or more of the plurality of electrodes 210 insulated from the liquid lens 115, to thereby adjust one or both of a lateral position 230 or contact angle 150 of the lens 115. The voltage (V) can be formed by selectively biasing the electrodes 210 with respect to a biasing electrode 220 (or an electrically conductive substrate 105) in contact with the liquid lens 115.

In some cases tuning includes increasing a focal length 145 of the liquid lens 115 by applying a voltage (V) to the liquid lens 115. E.g., when the voltage is applied, the contact angle 150 of the liquid lens 115 decreases, thereby increasing the focal length. In other cases, tuning includes decreasing a focal length 145 of the liquid lens 115 by removing a voltage (V) applied to liquid lens 115. A non-conductive non-polar liquid lens 115 could be similarly tuned by apply a voltage between a retaining fluid 120 comprising an electrically conductive polar liquid, and the plurality of electrodes 210.

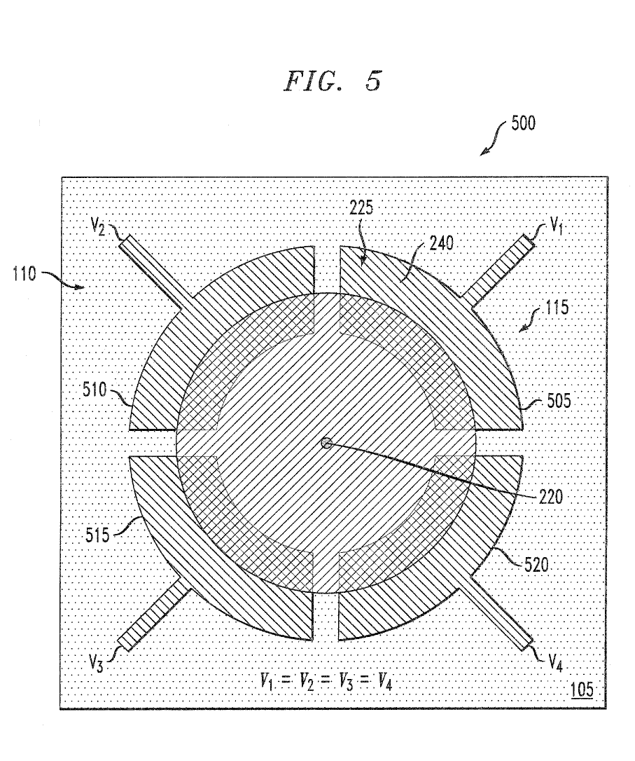

Tuning the liquid lens is not limited to tuning a liquid droplet, however. E.g., the apparatus 400 shown in FIG. 4 (using the same reference numbers as in FIGS. 1-2) can comprise a liquid lens 115 and retaining fluid 120 can be configured to provide a substantially planar refractive index contrast interface 140. Such embodiments of the apparatus 400 can include a 2-dimensional array of electrodes 210 arranged under the liquid lens 115 and retaining fluid 120 similar to that depicted in FIGS. 1-2. By appropriately activating selected electrodes 210, the shape of the planar interface 140 can be made locally non-planar. That is, there can be local changes in the shape of the liquid lens 115, as characterized by local changes in the liquid lens's 115 lateral position or contact angle, analogous to that discussed above in the context of the liquid lens configured as a droplet (FIGS. 1-2). Consequently, the interface 140 can be tuned so as to compensate for aberrations in an incident light 135 being passed through the lens 115. This could provide a simple alternative to, e.g., maskless lithography based on solid lenses or other methods of adaptive optical wavefront compensation.

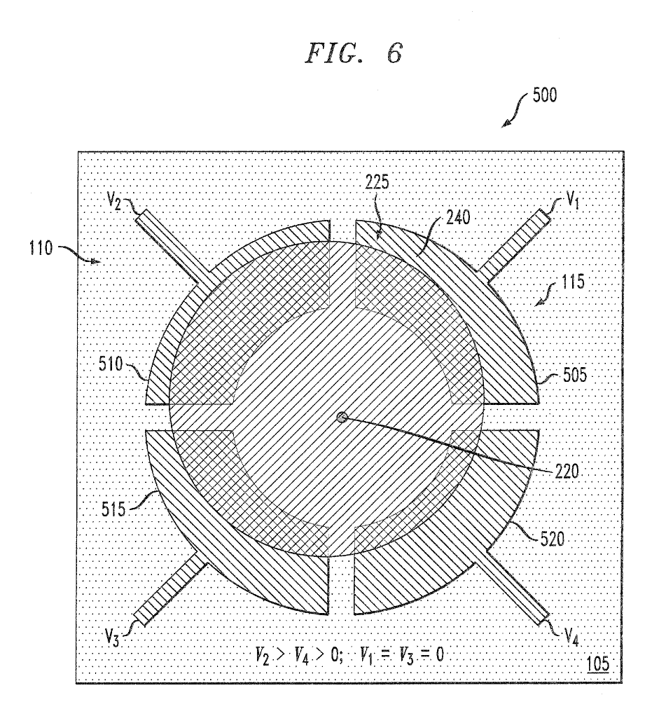

An example tunable liquid lens 115 at different stages of use is illustrated in FIGS. 5 and 6, which show semi-transparent plan views of a portion of the apparatus 500 depicted in FIG. 2 along view line 5-5. For clarity, certain features such as the surrounding retaining fluid 120 (FIG. 2) are not shown. When voltages V₁, V₂, V₃, V₄ applied to each the electrodes 505, 510, 515, 520 (analogous to the electrodes 210 depicted in FIG. 2) are all equal to each other (e.g., V₁=0, V₂=0, V₃=0, V₄=0), then the liquid lens 115 is located centrally between the electrodes 505, 510, 515, 520. As shown in FIG. 6, the liquid lens 115 can be moved towards the electrode 510 whose biased voltage is made greater than zero Volts and greater than a diagonally positioned electrode 520 (e.g., V₂>V₄>0), and the remaining two electrodes 505, 515 have zero voltage (e.g., V₁=V₃=0).

Although the present invention has been described in detail, those of ordinary skill in the art should understand that they can make various changes, substitutions and alterations herein without departing from the scope of the invention.

What is claimed is:

1. An apparatus, comprising:
a substrate with a top surface;
a liquid lens on said top surface;
a clear retaining fluid surrounding said lens; and
wherein one of said retaining fluid and said liquid lens comprises a nonpolar liquid, and the other of said retaining fluid and said liquid lens comprises a polar liquid, and said nonpolar liquid includes one or more cyclic saturated organic compounds.

2. The apparatus of claim 1, wherein said polar liquid said non-polar liquid are substantially immiscible in each other.

3. The apparatus of claim 1, wherein said cyclic saturated organic compounds includes a polycyclic cycloalkane.

4. The apparatus of claim 1, wherein said cyclic saturated organic compound includes a first cyclic saturated organic compound having two- or three-ring polycyclic cycloalkane, and a second cyclic saturated organic compound having four-ring or larger polycyclic cycloalkane.

5. The apparatus of claim 1, wherein a difference in a refractive index of said nonpolar liquid and a refractive index of said polar liquid is at least about 0.15.

6. The apparatus of claim 1, wherein said polar liquid comprises water.

7. The apparatus of claim 1, wherein said polar liquid comprise molten salts.

8. The apparatus of claim 1, wherein said cyclic saturated organic compound has an index of refraction ranging from about 1.5 to 1.6 and said polar liquid has an index of refraction ranging from about 1.3 to 1.4.

9. The apparatus of claim 1, wherein a ratio of an index of refraction of said nonpolar liquid to an index of refraction of said polar liquid ranges from about 1.13 to 1.2.

10. The apparatus of claim 1, wherein said liquid lens is configured as a droplet.

11. The apparatus of claim 1, wherein a ratio of a focal length to a radius of said liquid lens ranges from about 3.7:1 to 5.8:1.

12. The apparatus of claim 1, further including:
an insulating layer on said substrate; and
a plurality of electrodes insulated from said liquid lens by said insulating layer, wherein
said substrate includes a biasing electrode that is in contact with said liquid lens;
one of said liquid lens and said retaining fluid is electrically conductive and is disposed over a surface of said insulating layer and the other of said liquid lens and said retaining fluid is non-conductive, and
said plurality of electrodes are configured to adjust a lateral position or a contact angle of said liquid lens relative to said surface when a voltage is applied between said biasing electrode and one or more of said electrodes.

13. The apparatus of claim 1, wherein said apparatus is configured as an optoelectronic device further including:
a transmitter, said transmitter providing an optical signal; and
a receiver, said receiver receiving said optical signal, and wherein said liquid lens is configured to direct said optical signal from said transmitter to said receiver.

14. A method, comprising:
transmitting an optical signal using a liquid lens, including:
directing said optical signal towards said liquid lens, said liquid lens being located a top surface of a substrate and surrounded by a clear retaining fluid;
refracting said optical signal at an interface between said liquid lens and said retaining fluid; and
passing said refracted optical signal onto a receiving surface,
wherein one of said retaining fluid and said liquid lens comprises a nonpolar liquid, and the other of said retaining fluid and said liquid lens comprises a polar liquid, and said nonpolar liquid includes a cyclic saturated organic compound.

15. The method of claim 14, wherein refracting said optical signal through said liquid lens and said retaining fluid focuses said optical signal.

16. The method of claim 14, wherein passing said optical signal through said liquid lens and said retaining fluid diverges said optical signal.

17. The method of claim 14, wherein a focal length between said liquid lens and said receiving surface ranges from about 3.7 to 5.9 times a radius of said liquid lens.

18. The method of claim 14, further including tuning said liquid lens by changing said liquid lens's shape.

19. The method of claim 18, wherein tuning includes increasing a focal length of said liquid lens is by applying a voltage to said liquid lens.

20. The method of claim 18, wherein tuning includes decreasing a focal length of said liquid lens by removing a voltage applied to said liquid lens.
